(19) United States
(12) Patent Application Publication
(10) Pub. No.: US 2007/0020012 A1
(43) Pub. Date: Jan. 25, 2007

(54) Ribbon module structure of label printer

(76) Inventors: Feng-Yi Tai, Chung-Ho City (TW); Jung-Chin Chang, Chung-Ho City (TW)

Correspondence Address: Connolly Bove Lodge & Hutz, LLP, P.O. Box 2207, Wilmington, DE, 19899-2207, US

(21) Appl. No.: 11/187,142

(22) Filed: Jul. 22, 2005

(51) Int. Cl. B41J 17/02

(52) U.S. Cl. 400/236.2; 400/236

(57) ABSTRACT

A ribbon module structure of label printer comprises a frame, a supply axle, and a retrieve axle. A turning apparatus is installed in one side of the supply axle and a driving apparatus is installed in the retrieve axle. The turning apparatus has a connecting means and a control means. The connecting means rotates synchronously with the supply axle and rotates clock-wise/counter-clockwise according to the position relative to the control means for providing two retrieve modes of ribbon.

### BACKGROUND OF THE INVENTION

1. Field of the Invention

The present invention relates to a ribbon module structure of label printer, and more particularly to a ribbon module structure capable of retrieving ribbons with different transfer printing sides.

2. Description of the Prior Art

Recently, the label printer is a body installed with a principal part and an axle. A label roll is putted on the axle. The principal part comprises a ribbon frame and a printing frame. The printing frame is installed with two rotating axles, and one axle thereof is driven by a driving apparatus. Thermal transfer ribbons are put on the two axles. Therefore, the label and the thermal transfer ribbon are synchronously driven by the principal part, and characters and images are transferred on the label from the thermal ribbon by a print head. However, the conventional thermal ribbons are classified into inside and outside types according to the coated side of thermal material of the ribbon. That limits the usage of the conventional label printer. Hence, the thermal ribbon label printer suitable to inside and outside types has developed. Nevertheless, the switch of the label printer between the inside and outside types has to be done manually by a user, and the rotating retrieve angle of the thermal ribbon is narrow. Therefore, the user is hard to check the printed content of the label.

### SUMMARY OF THE INVENTION

In view of the problems of related conventional arts, a main objective of the present invention is to provide a ribbon module structure of label printer suitable to inside and outside types of thermal ribbon by means of a turning apparatus installed on a side of a supply axle.

Hence, the present invention discloses a ribbon module structure of label printer. The ribbon module structure comprises a frame, a supply axle, and a retrieve axle. A turning apparatus is installed in one side of the supply axle and a driving apparatus is installed in the retrieve axle. The turning apparatus has a connecting means and a control means. The connecting means rotates synchronously with the supply axle and rotates clock-wise/counter-clockwise according to the position relative to the control means for providing two retrieve modes of ribbon.

### BRIEF DESCRIPTION OF THE DRAWINGS

FIG. 1 is 3D assembly diagram of the present invention;

FIG. 2 is 3D diagram of the present invention;

FIG. 3 is a operational diagram of the present invention; and

FIG. 4 is another operational diagram of the present invention.

### DESCRIPTION OF THE PREFERRED EMBODIMENT

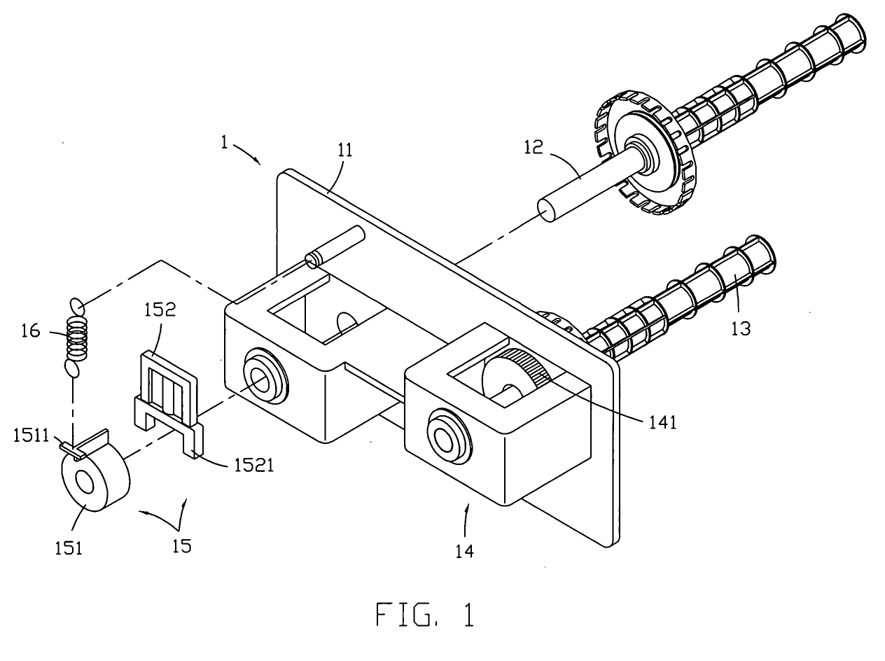

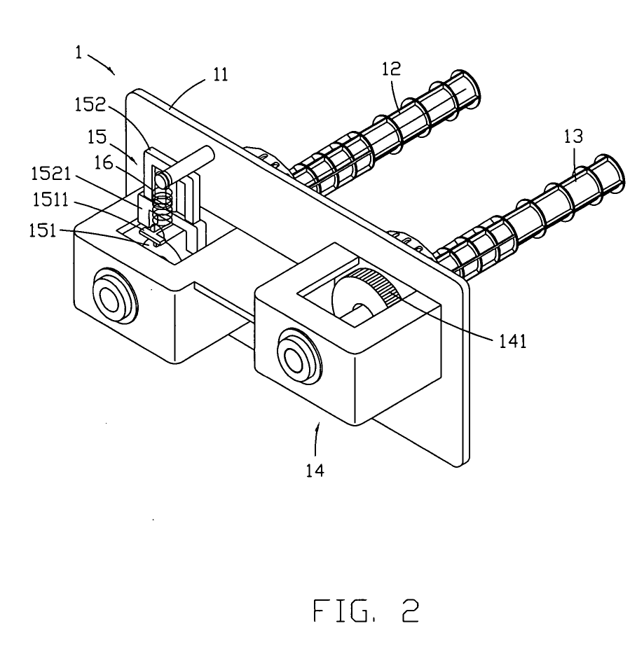

Referring to FIGS. 1 and 2, these are 3D assembly diagram and 3D diagram of the present invention respectively. A ribbon module 1 is installed in a label printer. The ribbon module 1 has a frame 11 in that a supply axle 12 and a retrieve axle 13 are installed. The retrieve axle 13 is driven by a driving apparatus 14 in that a driving gear 141 is installed. A turning apparatus 15 is installed on the supply axle 12.

The turning apparatus 15 comprises a connecting means 151 and a control means 152. The connecting means 151 is assembled in one side of the supply axle 12 and has an extended stop arm 1511 installed thereon. The stop arm 1511 of the connecting means 151 forms a flexible connection with the frame 11 via a flexible device 16. Furthermore, the control means 152 is movably installed on the frame 11. Two blocking arms 1521 are extended downward from two sides of the control means 152, and so the control means 152 on the frame 11 can shift leftward and rightward with a shifting distance.

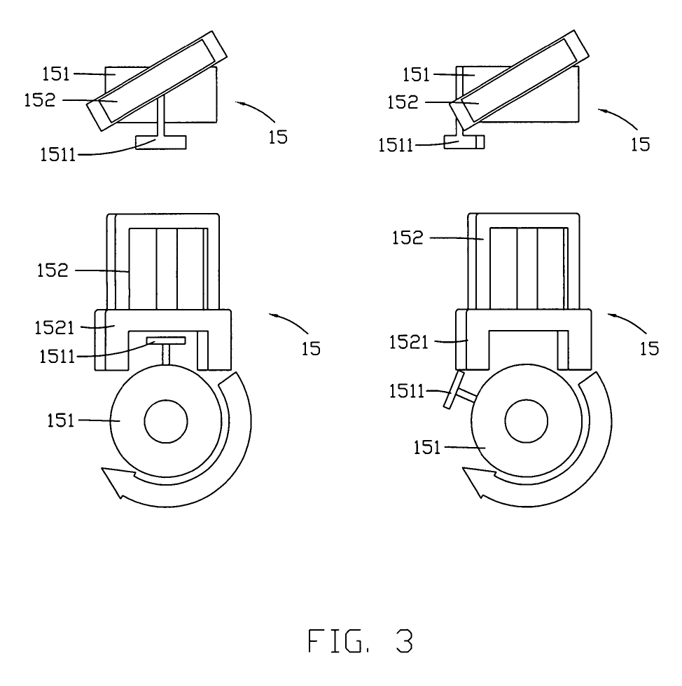

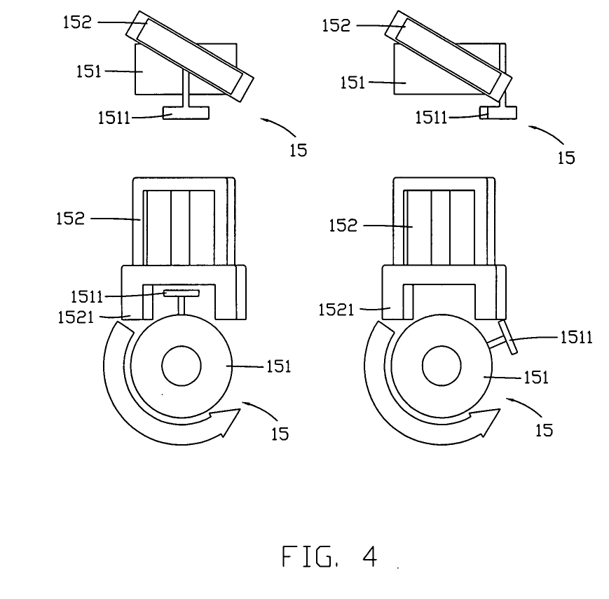

Referring to FIGS. 3 and 4, these are operational diagrams of the present invention. In practice, the ribbon module 1 is one of various assembly modules of label printers, other assembly modules are not the claiming scope of the present invention and are well-known structures, and so the present invention would not describe those structure. However, the general thermal ribbons are classified into inside type and outside type according to coated positions of thermal materials coated on the ribbon. Therefore, the supply 12 has to rotate the thermal ribbon clock-wise or counter-clockwise according to the coated positions of the thermal materials. As shown in the FIGS. 3 and 4, the control means 152 of the turning apparatus 15 is prepared to shift an appropriate distance according to the type of the thermal ribbon. At this time, the two blocking arms 1521, on two sides of the control means 152, form a closed end and an open end relative to the frame 11. The stop arm 1511 of the connecting means 151 is to bar the blocking arm 1521 on the closed end, and so the connecting means 151 only can drive the thermal ribbon to unidirectionally rotate to the side of the open end. In addition, after the control means 152 shifted to the other side, the closed end and the open end of the blocking arms 152 relative to the frame 11 are exchange with each other. The rotating direction of the connecting means 151 reverses at this time and unidirectionally rotate with the other direction. Hence, the connecting means 151 has clock-wise and counter-clockwise rotating directions to match the two types of thermal ribbons.

Although specific embodiments have been illustrated and described, it will be obvious to those skilled in the art that various modifications may be made without departing from what is intended to be limited solely by the appended claims.

What is claimed is:

1. A ribbon module structure of label printer, comprising:
a ribbon module installed in the label printer;
a frame installed on said ribbon module;
a supply axle installed on said frame, said supply axle having a turning apparatus that comprises a connecting means installed in one side of said supply axle and a control means installed on said frame; and
a retrieve axle installed on said frame and driven by a driving apparatus;
wherein said control means shifts to left and right sides to make said supply axle rotate clock-wise/counter-clockwise according to the oscillation of said control means while said supply axle rotates with said connecting axle.

2. The ribbon module structure according to claim 1, wherein said control means comprises two extended blocking arms, said connecting means comprises a stop arm, and said control means rotates to an opposite direction while one of said blocking arms collides with said stop arm.

3. The ribbon module structure according to claim 2, wherein a flexible device is assembled between said stop arm and said frame.

4. The ribbon module structure according to claim 1, wherein said driving apparatus of said retrieve axle is installed with a driving gear.
